(19) United States
(12) Patent Application Publication
(10) Pub. No.: US 2007/0150320 A1
(43) Pub. Date: Jun. 28, 2007

(54) ITINERARY PLANNING SYSTEM AND METHOD

(75) Inventor: Hsing-Yung Huang, Taoyuan (TW)

Correspondence Address: ISHIMARU & ZAHRT LLP, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 11/534,644

(22) Filed: Sep. 23, 2006

(30) Foreign Application Priority Data
Dec. 22, 2005 (TW) 094145808

(51) Int. Cl. G06Q 10/00

(52) U.S. Cl. 705/5

(57) ABSTRACT

An itinerary planning system and method applicable to data processing systems is proposed, comprising: a database having travel information and itinerary planning conditions; a setting module for receiving information on itinerary planning conditions set by the user; a searching module for retrieving from the database the travel information that corresponds to itinerary planning conditions set by the user; and a planning module for creating an itinerary based on itinerary planning conditions and the correspondent travel information retrieved from the database, thereby building an itinerary from the database according to itinerary planning conditions set by the user.

### FIELD OF THE INVENTION

The present invention relates to data processing technologies, and more particularly, to an itinerary planning system and method using data processing technologies.

### BACKGROUND

The planning of recreational activities has become increasingly important with the expansion of leisure time along with the increase in spendable income. The increasing availability of automobiles and intercity highways makes it convenient for people to travel independently. Also, with the assistance and popularity of recreational vehicles, people nowadays are more accustomed to traveling to scenic spots of interest by driving cars themselves as opposed to commercial transportation.

To find all possible reasonable routes to reach a desired destination, drivers have had to rely on printed maps alone to plan their travel and provide directions. This mode of planning has several disadvantageous, for example, the update of such printed map versions is way too slow to provide the latest travel information, and, in addition, it is impossible to look at a map and drive at the same time for obvious safety reasons. Therefore, it is quite inconvenient for people who do not have a good sense of direction or drivers who are unfamiliar with certain geographical locations. Additionally, paper maps cannot provide real-time information on weather or traffic conditions. In order to be advised of such conditions, drivers would have to gather related information beforehand or obtain weather and/or traffic information in real time by trying to listen to radio broadcasts while driving.

Advances in electronics and information technologies enable satellite navigation devices to be integrated with mapping information, tourist spots, and even real-time travel information, and have become standard vehicle equipment for many drivers nowadays. While such satellite navigation devices integrated with satellite navigation hardware/software and electronic mapping software can overcome the disadvantageous of using printed maps for travel guidance, navigation information can only be generated in a passive manner solely based on the conditions provided by the user. Specifically, such systems generally only allow the user to input one starting point and one end point to enable a conventional satellite navigation device to do real-time navigation of planning routes based on reasonable assumptions (such as the desirability for the shortest distance, the least congested routes, or routes without accidents and so on). However, if the user would like to integrate multiple locations and destinations into a single route, each chosen location/destination has to be input to allow the satellite navigation device to plan travel itineraries accordingly.

Therefore, the conventional satellite navigation device can only make travel itinerary plans in a passive way instead of an integrated and convenient manner according to the location/destination information input by the user. If the user is unfamiliar with a particular destination region, then the user may not choose the most interesting activities available, thus preventing the user from taking full advantage of the experiences available at the chosen travel destination. In addition, for users who do not have specific locations/destinations in mind or are not familiar with route information, it is difficult for them to provide the satellite navigation system with sufficient information so that the system can plan an ideal itinerary accordingly. Moreover, the conventional satellite navigation device can only plan an itinerary based on a chosen destination input by the user without regard to other travel conditions such as the timing, region, and season, which, ideally, would be integrated for further reference and selection. Thus, the conventional satellite navigation system lacks flexibility and doesn't provide diversity in generating itineraries.

### SUMMARY OF THE INVENTION

In light of the drawbacks in the prior arts, a primary objective of the present invention is to provide an itinerary planning system and method that is capable of planning at least one valid itinerary based on the given itinerary planning conditions in addition to the desired destination.

To achieve the above and other objectives, the present invention proposes an itinerary planning system that is applicable to data processing systems, comprising: a database having travel information and itinerary planning conditions; a setting module for receiving information about itinerary planning conditions set by the user; a searching module for retrieving from the database information corresponding to itinerary planning conditions set by the user; and a planning module for creating an itinerary based on itinerary planning conditions and the retrieved information.

In one form of the present invention, the travel information encompasses information on pre-packaged tours, theme tours, transportation tools, geographic locations and weather forecasts.

In one form of the present invention, the itinerary planning conditions include information correspondent to keywords of the travel information and individualized settings of the user.

In one form of the present invention, the data processing system is a network platform and interconnected with a data processing device having a network connection and data transmission capability by way of a network system, thereby transmitting the created travel itineraries generated by the planning module to the data processing device via the network system.

In one form of the present invention, the data processing device is a satellite navigation device.

The itinerary planning method comprises the steps of: establishing a database having travel information and itinerary planning conditions; receiving information on itinerary planning conditions set by the user; retrieving correspondent information from the database that matches with itinerary planning conditions set by the user; and generating an itinerary based on the itinerary planning conditions and the retrieved information.

Compared to the prior art, the itinerary planning system and method proposed by the present invention is capable of presenting multiple itineraries according to the preset itinerary planning conditions rather than simply relying on a chosen location/destination, thereby realizing the goal of providing diversified as well as optimal traveling itineraries for further consideration and selection.

### BRIEF DESCRIPTION OF THE DRAWINGS

The itinerary planning system and method of the present invention can be fully understood by reading the following detailed description of the preferred embodiments, with reference made to the accompanying drawings, wherein:

FIG. 1 is a block diagram showing the application configuration of the itinerary planning system in accordance with the present invention; and

FIG. 2 is a data flow diagram showing the steps needed to carry out the itinerary planning method in accordance with the present invention.

### DESCRIPTION OF THE PREFERRED EMBODIMENTS

The present invention is described in the following so that one skilled in the pertinent art can easily understand other advantages and effects of the present invention. The present invention may also be implemented and applied according to other embodiments, and the details may be modified based on different views and applications without departing from the spirit of the invention.

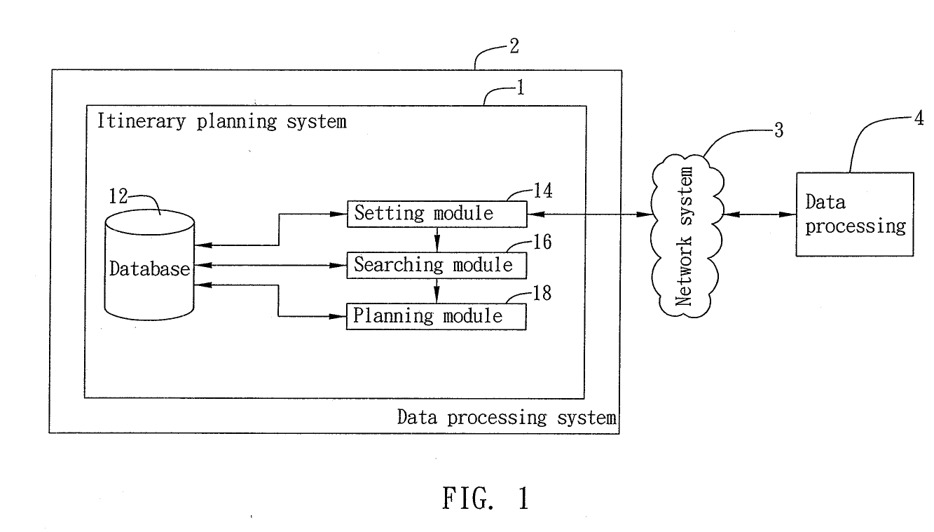

FIG. 1 is a schematic diagram showing the application configuration of the itinerary planning system in accordance with the present invention. As shown, the itinerary planning system 1 of the present invention is applicable to a data processing system 2, the data processing system 2 being a network platform which interconnects with a data processing device 4 having a network connection and data transmission capability for transmitting data therebetween via a network system 3, wherein the data processing device 4 is a satellite navigation device. In a preferred embodiment of the present invention, the data processing device 4 further includes other data processing abilities, and preferably a satellite navigation capability such as a PDA, a cellular phone, or a notebook computer.

The itinerary planning system 1 of the present invention comprises: a database 12, a setting module 14, a searching module 16, and a planning module 18.

The database 12 is used to store travel information and itinerary-planning conditions set by the user. In this embodiment, the travel information includes pre-packaged itineraries, theme itineraries, transportation tools, geographical locations, and weather forecasts.

Specifically, the travel information about pre-packaged itineraries further includes introductions of tourist spots, tickets and passes, reservations for hotels and restaurants, stores, hours of operation and recommended times for visiting. The travel information about theme itineraries further includes regional themes, scenic spots themes, and seasonal themes. The travel information about transportation tools further includes foot travel, land/sea/air public transportation tools, motorcycles, and vehicles. The travel information about geographical locations further includes administrative regions, detailed addresses, altitudes and road conditions. The travel information about weather forecasts further includes seasons, temperatures, humidity levels, rainfall ratios, cloud conditions, and forecasted times of sunrise and sunset.

The travel itinerary planning conditions set by the user include keywords corresponding to travel information and individualized settings of the user. For example, if the travel information were an introduction to tourist spots of a package tour and the scenic spot was “Yang-Ming Mountain,” then the keywords thereof could be, among others, “Yang-Ming Mountain,” “National Park,” “flower,” “Flower Season,” “hot spring” and so on.

The setting module 14 is used to receive information on keywords of itinerary planning conditions and one or more user's individualized settings. In this embodiment, the itinerary planning system 1 of the present invention is applicable to a data processing system 2 and interconnects with a data processing device 4 having a network connection and data transmission capability for transmitting data therebetween via a network system 3. Therefore, the setting module 14 is used to receive information on keywords of itinerary planning conditions and users' individualized settings, which are transmitted from the data processing device 4 via the network system 3.

The searching module 16 is used to search from the database 12 keywords of travel information that match with the travel itinerary planning conditions. As discussed above, if the user uses the data processing device 4 via the network system 3 to set the travel itinerary planning conditions that include keywords of “winter,” “Taipei city,” “starting point—Section 5 Hsin-Yi Road,” “from near to far,” “the shortest itinerary,” “one day trip,” “small bus,” “hot spring,” “antiques,” “skyscraper,” “night market,” or similar, the searching module 16 searches the database 12 for keywords of travel information that correspond to such keywords. For example, in this embodiment, the searching module 16 will search out and present travel information such as “Yang-Ming Mountain Ma-Zhou Hot Spring Hotel,” “Bei-Tou Spring Hotel,” “Palace Museum,” “101 Building,” “Shin-Kong Mitsukoshi Building” and so on.

The planning module 18 is used to create and generate travel itineraries based on users' individualized settings for the travel itinerary planning conditions and travel information retrieved by the searching module 16. As discussed above, based on the travel information searched on by the searching module 16 against the database 12, the planning module 18, based on users' individualized settings of “starting point—Section 5 Hsin-Yi Road,” “from near to far,” “the shortest itinerary,” “one-day trip,” and “small bus,” generates two types of travel itineraries for a one-day Taipei City tour that includes the “101 Building” >the “Palace Museum” > “Yang-Ming Mountain Ma-Zhou Hot Spring Hotel,” or, alternately, the “History Museum” > “Shin-Kong Mitsukoshi Building” > and the “Bei-Tou Spring Hotel.” The former itinerary is the shortest route calculated from the “101 Building” to the “Palace Museum” using all possible routes to travel passing through a viaduct, and the latter is the shortest route calculated from the “starting point—Section 5 Hsin-Yi Road” to the “History Museum” by all possible routes of foot travel such as via Jen-Ai Road.

It is to be noted that the planning module 18 can also generate travel itineraries based on information about the hours of operation or the range of fees and prices of a commercial place according to users' individualized settings for travel itinerary planning conditions and should not be limited to the foregoing examples. In another embodiment of the invention, if the travel itinerary planning condition is changed from “one-day” to “two days,” the planning module 18 can schedule a two-day Taipei City tour, for example, the first day: the “History Museum” > “Shin-Kong Mitsukoshi Building” > and “Bei-Tou Spring Hotel”; the second day: the “Palace Museum” > the “101 Building,” thereby returning to a point close to “starting point—Section 5 Hsin-Yi Road.” Of significance is the fact that the user may set up a travel itinerary by himself/herself using a data processing device 4. When the user confirms a travel itinerary, the data processing device 4 can download and save the travel itinerary from the data processing system 2 via the network system 3, allowing the data processing device to subsequently navigate the tour based on the verified itinerary.

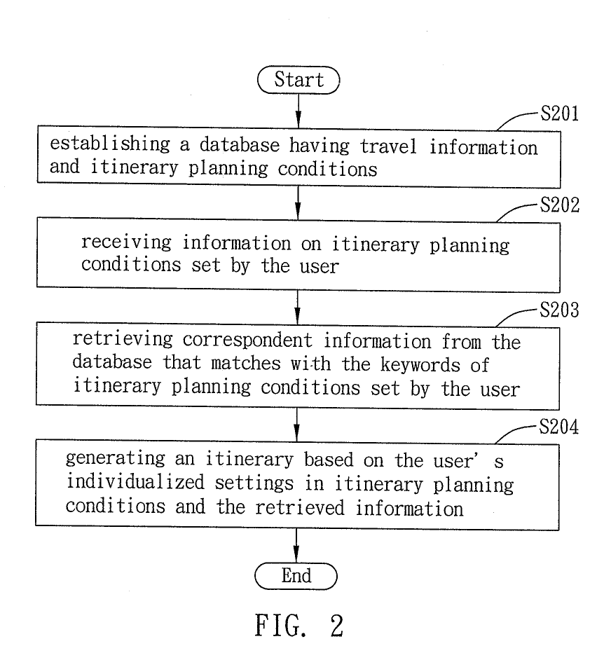

FIG. 2 is a flow diagram showing the steps for executing the itinerary planning method using the itinerary planning system 1 of the present invention. As shown, in step S201, a database 12 having travel information and itinerary planning conditions is established. In this embodiment, the travel information encompasses but is not limited to, information on pre-packaged tours, theme tours, transportation tools, geographic locations and weather forecasts; the itinerary planning conditions include but are not limited to, information corresponding with keywords for travel information and the user's individualized settings. Thereafter, step S202 is executed.

In step S202, the itinerary planning conditions set by the user are received. In this embodiment, the setting module 14 is used to receive the itinerary planning conditions set by the user via the data processing device 4 and transmitted via the network system 3. Thereafter, step S203 is executed.

In step S203, travel information corresponding to search keywords specifying travel itinerary planning conditions is retrieved from the database 12. In this embodiment, the user selects or enters keywords for travel itinerary planning conditions via the data processing device 4 and transmits the same via the network system 3, then the searching module 16 is used to retrieve from the database 12 locations or points-of-interest or other related travel information that match with the travel itinerary planning conditions. Thereafter, step S204 is executed.

In step S204, an itinerary is generated based on the information specified in the user's individualized settings for the travel itinerary planning conditions and also on the information retrieved by the searching module 16. Moreover, when the user confirms the travel itinerary, the data processing device 4 downloads and saves the verified itinerary via the network system 3, thereby the data processing device can subsequently navigate the tour based on the verified itinerary.

In summary, by the provision of a database, a setting module, a searching module and a planning module, the itinerary planning system and method proposed by the present invention can present multiple travel itineraries according to the preset itinerary planning conditions other than just a chosen destination, thereby realizing the goal of providing more diversified itineraries for selection.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

What is claimed is:

1. An itinerary planning system applicable to data processing systems, comprising:
a database having travel information and itinerary planning conditions;
a setting module for receiving information on itinerary planning conditions set by a user;
a searching module for retrieving from the database the travel information that corresponds to itinerary planning conditions set by the user; and
a planning module for creating an itinerary based on itinerary planning conditions and the correspondent travel information retrieved from the database.

2. The itinerary planning system of claim 1, wherein the travel information encompasses information about pre-packaged tours, theme tours, transportation tools, geographic locations and weather forecasts.

3. The itinerary planning system of claim 2, wherein the travel information about pre-packaged itineraries further includes introductions of tourist spots, tickets and passes, reservations for hotels and restaurants, commercial stores, the hours of operation and recommended times for visiting, wherein the travel information about theme itineraries further includes regional themes, scenic spots themes, and seasonal themes; the travel information about transportation tools further includes foot travel, land/sea/air public transportation tools, motorcycles, and vehicles; the travel information about geographical locations further includes administrative regions, detailed addresses, altitudes and road conditions; and the travel information about weather forecasts further includes seasons, temperatures, humidity levels, rainfall ratios, cloud conditions, and forecasted times for sunrise and sunset.

4. The itinerary planning system of claim 1, wherein the itinerary planning conditions include information correspondent to keywords for the travel information and individualized settings of the user.

5. The itinerary planning system of claim 4, wherein the searching module searches and retrieves from the database keywords for travel information that match with the travel itinerary planning conditions.

6. The itinerary planning system of claim 4, wherein the planning module generates an itinerary based on the users' individualized settings in the travel itinerary planning conditions and the travel information retrieved by the searching module.

7. The itinerary planning system of claim 1, wherein the data processing system is a network platform and interconnected with a data processing device having a network connection and data transmission capability by way of a network system.

8. The itinerary planning system of claim 7, wherein the itinerary planning conditions are set by the user using the data processing device and transmitted to the setting module via the network system.

9. The itinerary planning system of claim 7, wherein the data processing device downloads and saves an itinerary from the data processing system via the network system.

10. The itinerary planning system of claim 7, wherein the data processing device is a satellite navigation device.

11. An itinerary planning method applicable to data processing systems, the method comprising the steps of:
(1) establishing a database having travel information and itinerary planning conditions;
(2) receiving information on itinerary planning conditions set by a user;
(3) retrieving correspondent information from the database that matches with itinerary planning conditions set by the user; and
(4) generating an itinerary based on the itinerary planning conditions and the correspondent travel information retrieved from the database.

12. The itinerary planning method of claim 11, wherein the travel information encompasses information on pre-packaged tours, theme tours, transportation tools, geographic locations and weather forecasts.

13. The itinerary planning method of claim 12, wherein the travel information about pre-packaged itineraries further includes introductions of tourist spots, tickets and passes, reservations for hotels and restaurants, stores, hours of operation and recommended times for visiting, wherein the travel information about theme itineraries further includes regional themes, scenic spots themes, and seasonal themes; the travel information about transportation tools further includes foot travel, land/sea/air public transportation tools, motorcycles, and vehicles; the travel information about geographical locations further includes administrative regions, detailed addresses, altitudes and road conditions; and the travel information about weather forecasts further includes seasons, temperatures, humidity levels, rainfall ratios, cloud conditions, and forecasted times for sunrise and sunset.

14. The itinerary planning method of claim 11, wherein the itinerary planning conditions include information correspondent to keywords for the travel information and individualized settings of the user.

15. The itinerary planning method of claim 14, wherein step (3) comprises retrieving from the database keywords of travel information that match with travel itinerary planning conditions set by the user.

16. The itinerary planning method of claim 14, wherein step (4) comprises generating travel itineraries based on the users' individualized settings in the travel itinerary planning conditions and the correspondent information retrieved by step (3).

17. The itinerary planning method of claim 11, wherein the data processing system is a network platform and interconnected with a data processing device having a network connection and data transmission capability by way of a network system.

18. The itinerary planning method of claim 17, wherein the step of receiving itinerary planning conditions set by the user refers to receiving itinerary planning conditions set by the user using the data processing device and transmitted via the network system.

19. The itinerary planning method of claim 17, wherein the data processing device downloads and saves an itinerary from the data processing system via the network system.

20. The itinerary planning method of claim 17, wherein the data processing device is a satellite navigation device.
